(19) United States
(12) Patent Application Publication
(10) Pub. No.: US 2007/0298758 A1
(43) Pub. Date: Dec. 27, 2007

(54) METHOD AND APPARATUS FOR NOTIFICATION OF DISASTERS AND EMERGENCIES

(76) Inventors: Dinesh Chandra Verma, Mount Kisco, NY (US); Paridhi Verma, Mount Kisco, NY (US)

Correspondence Address: Whitham, Curtis, & Christofferson, P.C., Suite 340, 11491 Sunset Hills Road, Reston, VA, 20190, US

(21) Appl. No.: 11/426,447

(22) Filed: Jun. 26, 2006

(51) Int. Cl. H04M 11/04

(52) U.S. Cl. 455/404.1

(57) ABSTRACT

The present invention provides round-the-clock, in-home emergency notification service by employing wide-area wireless broadband servers to send alerts on an as-needed basis to notification terminals comprised of no-frills, battery-operated, in-home units which may be manufactured and packaged in a manner similar to smoke detectors and carbon monoxide detectors.

### BACKGROUND OF THE INVENTION

1. Field of the Invention

The present invention generally relates to the dissemination of emergency notifications to the public.

2. Background Description

The need for a system of ubiquitous emergency notification has been pointed out by the tragedies of recent major natural disasters, such as the Indian Ocean Tsunami of 2004, Hurricane Katrina in 2005, and the South Asia Earthquake of 2005. Natural disasters may occur at any time, including at night, when people who should be notified are asleep, or in other circumstances when significant numbers of people are not interacting with media such as television, radio, or the Internet, making them unreachable by notification systems such as the Emergency Alert System (EAS). For example, significant loss of life occurred as a result of the Evansville Tornado of 2005, which hit Evansville, Indiana, at 2:00 a.m. on Nov. 6, 2005, when most of the population of the city was asleep in bed and not reachable by EAS, which is limited to notifying people who are watching television or listening to the radio.

Many lives could be saved if a more effective way to alert people within a local geographic area could be developed. Proposals to address the problem by modifying existing systems have not been commercially practical because they would require consumers to make significant investments.

### SUMMARY OF THE INVENTION

The present invention cost-effectively provides round-the-clock, in-home emergency notification functionality. This is accomplished by employing wide-area wireless broadband networks (including, but not limited to, cellular telephone networks or, alternatively, networks employing 802.16b technology) to broadcast alerts on an as-needed basis to terminals which may be comprised of no-frills, battery-operated, in-home alarms capable of being manufactured and packaged in a manner similar to smoke detectors and carbon monoxide detectors.

Thus, from the end-user's perspective, the emergency notification device would be a consumer product operating in a manner similar to that of a smoke detector, except that it would be set off in response to information concerning a local or regional emergency instead of by the detection of a potential emergency, signaled by the presence of smoke or carbon monoxide, within the residence itself.

From a technical perspective, however, the emergency notification terminal of the present invention is unlike a smoke or carbon monoxide detector in that the terminal according to the present invention is a node on a network through which emergency alert information is distributed.

The present invention provides a terminal consisting of a low-power processor connected to memory (which may be a relatively small amount of memory), a network interface such as an 802.16 interface or a cellular telephone modem, and speakers. Such a terminal may also be equipped with a global positioning satellite (GPS) interface. A terminal according to the present invention may receive power from any of a variety of sources, including, but not limited to, standard disposable batteries, rechargeable batteries, house current, and/or house current with backup power coming from either disposable or rechargeable batteries.

Upon being installed in a residence, a terminal according to the present invention would initialize itself by identifying a compatible signal from an emergency alert server and then registering itself with the server. The registration process would result in the device being assigned a unique identifier on the network. At the time of an emergency alert, each emergency alert server would determine which (if any) of the devices registered to it ought to be alerted. Thus, the system could issue an alert either to all devices registered to particular emergency alert servers or to a subset of devices registered to particular emergency alert servers.

A terminal that lost all power (including backup power) could be dropped from the network and reinitialized when power was restored. Similarly, a disconnected terminal could be moved from one neighborhood to another and reinitialized in the new neighborhood without any change in the nature of service being apparent to the end-user.

The connection between the terminal and an appropriate emergency alert server employs wireless communication of sufficient bandwidth, including, but not limited to, an 802.16 communication interface or a cellular telephone modem. The capacity of the system to handle a given number of emergency alert terminals could be increased by increasing the number of emergency alert servers. Servers could be co-located with facilities providing broadband wireless service or cell-phone service.

Global position satellite (GPS) or other geolocation data, including, but not limited to, address or zip code data manually input at setup time or looked up automatically from a map based on GPS coordinates, may be used to narrow an emergency alert to a subset of devices served by a given emergency alert server. Alternatively, broader alerts may be transmitted to all emergency alert terminals being served by a particular emergency alert server regardless of whether the geolocation data is available for every terminal on the network. Thus, the present invention allows for emergency alert terminals with multiple levels of service, such as a basic level provided at a relatively low monthly service charge (potentially as low as zero) and a premium level, providing more finely tailored alerts and potentially alerts relating to non-life-threatening situations, at a higher monthly service charge.

A terminal according to the present invention includes a wireless network interface, a processor to process the signals from the wireless network interface, a user-notification system, and a power system. The wireless network interface could employ any available wireless communication standard, including, but not limited to, a cellular telephone connection, an 802.16 wireless connection, a connection employing portions of the broadcast spectrum by encoding emergency alert signals into television or radio signals.

A processor used to process the signals of the transceiver of the terminal may be a digital signal processor, an analog integrated circuit, or another device capable of processing emergency notification signals.

A user-notification system may be a simple audible alarm, an audible alarm and a visual display to provide more information and guidance than the audible alarm alone, or an alarm and a speaker by which an audio feed from the emergency notification servers at a central notification site may provide more information and guidance than the audible alarm alone. A user-notification system may also include a strobe light.

A power system for the terminal according to the present invention may consist of: battery power alone; house current with backup power from a disposable battery; house current with a rechargeable battery; solar power with a rechargeable battery; or any other power system found to be practical.

As an illustrative example of the manner in which this invention would be used, an emergency alert server may be connected via a wide area wireless networking protocol such as 802.16b, or a cellular telephone network, to several emergency alert terminals. The emergency alert server may be located, for example, at the offices of a nuclear power plant and may be able to communicate with emergency alert terminals within a radius of 25 miles. Homeowners in the surrounding area would be able to obtain one of the terminals and plug them into their electric outlets. When powered on, each terminal identifies its location using a GPS receiver built into the terminal and registers itself to the emergency notification server. The server then maps the GPS coordinates into a street address for the terminal and sends it back to the terminal. Assume an accident happens at the nuclear facility which requires the immediate evacuation of residents within a five-mile radius of the nuclear plant. The emergency alert server could identify those terminals that are within the evacuation area and then send them a downloadable audio or audio-visual file which (a) generates a loud alarm, (b) provides a concise description of the accident, and (c) informs each homeowner of the best evacuation route based on the home's location, as well as the location of an emergency shelter prepared to accommodate the residents of the home. The downloaded audio message would play repeatedly to inform the homeowners of the emergency situation. Even if the homeowners were sleeping, the alarm would wake them up and notify them of the emergency situation that has arisen. A rechargeable battery may serve as a backup power supply to allow the terminal to be active for a few hours in the case of power failure.

The present invention thus provides a method, a system, and a machine-readable medium with computer instructions for emergency notification comprising the steps of: using a computer connected to an emergency notification network to provide emergency notification data; using an emergency notification server connected to said emergency notification network to receive said emergency notification data; having a wireless network connected to said emergency notification server; using an emergency notification terminal connected to said wireless network to receive emergency notification data from said emergency notification terminal; and using a user notification system of said emergency notification terminal to distribute emergency notifications based on said emergency notification data. The wireless network may be a cellular telephone network, an 802.16 wireless broadband network, or another type of wireless network.

The present invention also provides an emergency notification terminal, comprising: means for obtaining location identification; receiver for receiving emergency notification alerts provided through said emergency notification network; and signaling mechanism for providing signals relating to one or more emergency notification alerts received by said receiver. The means for obtaining location identification information may comprise a GPS module or other global position determining device. Alternatively, the means for obtaining location information may comprise other means, including, but not limited to, manual entry of a zip code (either a five- or nine-digit code) or other postal code or manual entry of a land-line telephone number for the building in which the terminal is located. In addition, the means for obtaining location identification information may store the location information locally at said terminal and may compare the locally stored location information to rules received from the emergency notification network. The location information may be made available locally by storing it at the terminal, by providing it as output from a global positioning device built into the terminal, or otherwise. The means for receiving emergency notifications may interface to a wireless network, including, but not limited to, a cellular telephone network or an 802.16b wireless broadband network. The means for obtaining location identification information may include a terminal identifier which user transmits to the emergency notification network. The signaling mechanism for notifying users may generate an audible signal, may turn on a consumer electronic device, and/or may cause audio or visual equipment to be activated. The terminal may include an antenna for wireless connectivity to the emergency notification network. The receiver for receiving emergency alerts may compare a set of rules received from the emergency notification network to determine, on the basis of location information available locally at said terminal, whether an alert is applicable to said terminal. The location information may be made available locally by storing it at the terminal, by providing it as output from a global positioning device built into the terminal, or otherwise.

The emergency notification system according to the present invention comprises: a plurality of emergency notification terminals positioned at a plurality of different geographical locations, each of said emergency notification terminals capable of receiving emergency notification alerts provided through an emergency notification network, and providing signals related to one or more emergency notification alerts; a means for determining, on the basis of a terminal's location, whether an alert is applicable to said terminal; and a transmitter for transmitting one or more emergency notification alerts to one or more of said plurality of emergency notification terminals through said emergency notification network. The means for determining, on the basis of a terminal's location, whether an alert is applicable to said terminal may comprise a location registry which enables the emergency notification network to identify the location of each of said plurality of emergency notification terminals. Alternatively, the means for determining, on the basis of a terminal's location, whether an alert is applicable to said terminal may comprise a set of rules received from said emergency notification network which enables a terminal to determine, on the basis of location information available locally at said terminal, whether an alert is applicable to said terminal. The location information may be made available locally by storing it at the terminal, by providing it as output from a global positioning device built into the terminal, or otherwise. The transmitter may be capable of transmitting a first emergency notification alert to one subset of said plurality of emergency notification terminals and a second emergency notification alert which is different from said first emergency notification alert to a second subset of said plurality of emergency notification terminals. The transmitter may be capable of transmitting the emergency notification alerts to a subset of the emergency notification terminals selected on the basis of the locations of emergency notification terminals as identified in the location registry. The emergency notification system may include a processor for purposes of: receiving information from one or more sources which pertain to the emergency notification alerts; and enabling the transmitter to send emergency notification alerts to one or more of the emergency notification terminals based on the location of the emergency notification terminals. All or some of the emergency notification terminals may be able automatically to communicate location information which is incorporated into the location registry. All of some of the emergency notification terminals may be able to communicate by wireless communication. All or some of the emergency notification terminals may be equipped with global positioning systems. The emergency notification system may include at least one server which receives input alert information from and, based on the input alert information, generates one or more emergency notification alerts.

An emergency notification server according to the present invention may comprise: an alert user interface that allows users to input alert information; an alert generator module that allows for creation of an alert message; an terminal selector module to select a set of terminals to send an alert message; and an alert transmitter that transmits the alert message over a wireless network. The terminal selector module may use geographical location information to select the set of terminals that receive the alert message.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 shows an example of a system implemented with a machine-readable medium according the present invention.

FIG. 2 shows an emergency notification terminal according to the present invention.

FIG. 3 shows several alternate embodiments of an emergency notification terminal according to the present invention.

FIG. 4 shows an emergency notification server according to the present invention.

FIG. 5 shows an algorithm by which the emergency notification terminals can be configured in an automatic manner with geo-spatial information without the need for manual configuration.

FIG. 6 shows the state transition model of an emergency notification terminal during the course of its operation.

FIG. 7 shows an algorithm by which the emergency notification servers notify appropriate emergency notification terminals about emergencies in a locality.

### DETAILED DESCRIPTION OF A PREFERRED EMBODIMENT OF THE INVENTION

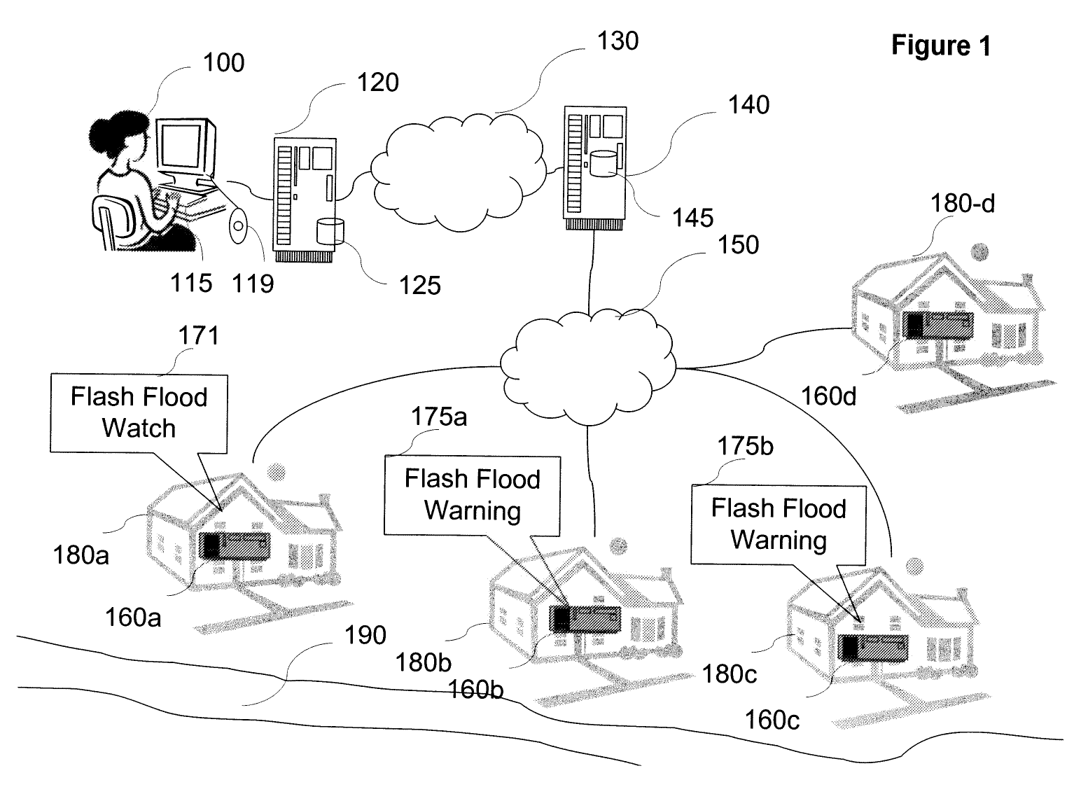

Referring now to the drawings, and more particularly to FIG. 1, there is shown an operator 100 using a keyboard 115 and mouse 119 to input an alert to a computer 120 connected to an emergency notification network 130. The computer 120 includes a machine-readable medium 125 containing instructions to enable the computer to perform emergency notifications according to the present invention. An emergency alert server 140 receives an emergency notification with distribution instructions and distributes a flash flood alerts over a wireless network 150 to registered terminals 160a, 160b, 160c located in residences 180a, 180b, 180c. The emergency alert server 140 includes a machine-readable medium 145 containing instructions to enable the computer to perform emergency notifications according to the present invention. A “Flash Flood Watch” notification 171 is transmitted to a residence 180a facing only moderate risk, while a “Flash Flood Warning” notification 175a, 175b is transmitted to residences 180b, 180c facing serious risk because of their elevation and proximity to a river 190. No notification at all is transmitted to a residence 180d which is not at risk by virtue of its elevation and/or distance from the river.

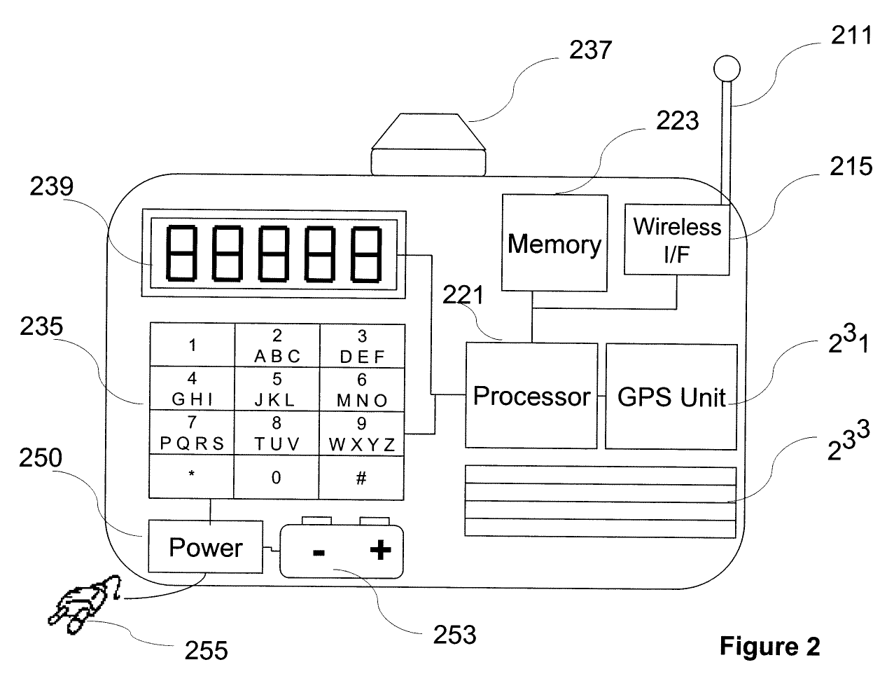

FIG. 2 shows a notification terminal according to the present invention. An antenna 211 is connected to a wireless network interface module 215, which is in turn connected to a processor 211 connected to memory 223. The processor 221 contains software (including, but not limited to, output drivers to provide alerts) for operation of the terminal. To the processor module 221 is connected a speaker 233, a flashing light 237, and a display 239 to provide emergency notifications according to the present invention, as well as other outputs. There is also a keypad 235 to provide inputs. A Global Positioning System (GPS) receiver 231 may be used to obtain the location of the terminal automatically. A power supply 250 is also connected to the system module 231, with a battery pack 253 and a power cord 255 that can be connected to the power supply in the house.

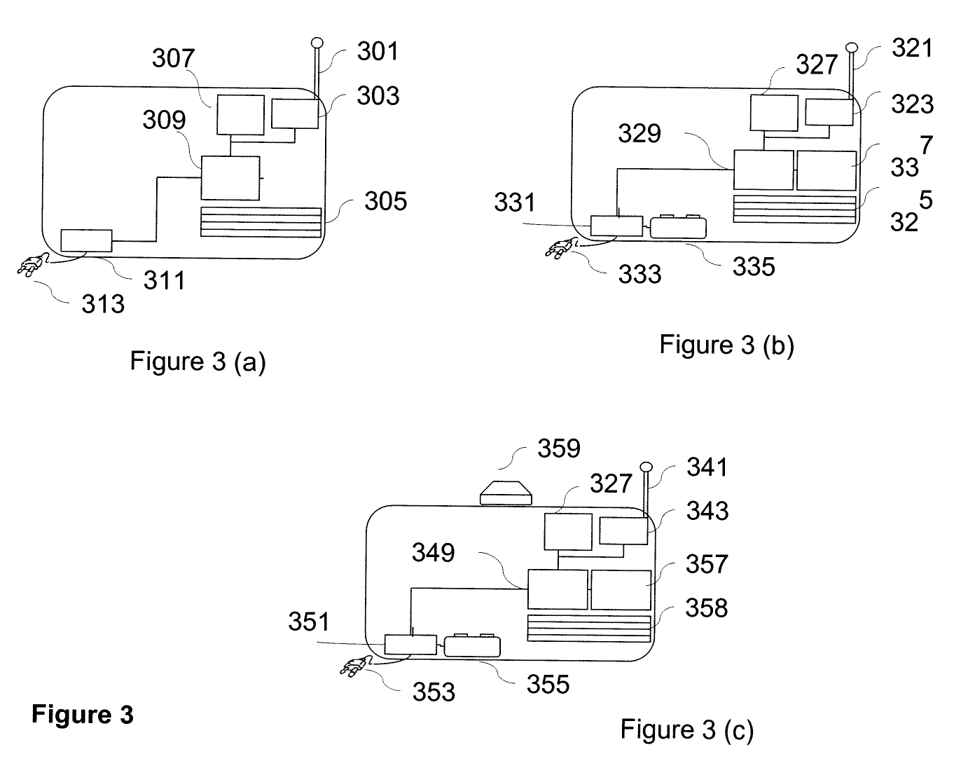

Many different variations of the embodiment described above can be made to create a variety of different types of emergency notification terminals. FIG. 3 shows three of those variations. FIG. 3(a) shows a very basic embodiment which only contains a minimum subset of functions. The basic terminal shown in FIG. 3(a) consists of an antenna 301 is connected to a wireless network interface module 303, which is in turn connected to a processor 309 connected to memory 307. A power supply 311 with a power cord 313 allows the terminal to function when it is connected to a household power supply. The basic terminal unit provided in the system does not provide a means of user input. However, the terminal can be used for user notification by having the terminal be registered with an emergency server using an out of band process. Such out-of-band process may include registering the terminal using a unique identifier (e.g. a manufacturer provided serial number) on a website provided by the emergency notification server. The registration process could include providing information such as the street address where the emergency alert terminal is installed. The emergency notification server can then send emergency notifications to the terminal as needed on the basis of its location.

An alternate embodiment is shown in FIG. 3(b). It consists of the components that are part of the basic version, an antenna 321, a wireless network interface module 323, a processor 329, memory 327, and a power supply 331 with a power cord 333. Furthermore, it contains a GPS module 337. The GPS module 337 receives GPS signals from the antenna 321 and uses it to determine its position. This position information can be used by the device to automatically register itself with any emergency alert server that may have connectivity with the terminal. The emergency alert server could translate the GPS coordinates into the location of a house, and map its proximity to physical entities such as rivers or lakes. Furthermore, the terminal consists of a battery pack 335. The battery pack 335 could provide power to the terminal when there is a power outage and no source of electric power is available. The battery pack 335 could consist of either an ordinary battery or a rechargeable battery. The rechargeable battery would be charged when the power cord 333 is plugged into an electric outlet, and supply power to the power supply 331 when the power cord is unplugged or if there is no external power.

FIG. 3(c) shows another alternative embodiment which includes a strobe light 359 in addition to the components shown in FIG. 3(b), i.e. an antenna 341, a wireless network interface module 343, a processor 349, battery 355, memory 358, a GPS module 357, and a power supply 351 with a power cord 353.

Yet another embodiment can be developed, which implements the terminal as an embedded device inside a television or radio. When a message from the emergency notification server is received, the embedded device employs the television or radio as a user notification device by turning on the television or radio and using the communications capability of the television or radio to present the alert and/or information about the alert. The volume on the radio or television can be increased progressively till the emergency notification is acknowledged by a human being, who can choose to turn the radio or television off. Other devices, e.g., set-top boxes, video players, or any other consumer, municipal, or other audio or visual equipment, may also be configured to turn on remotely to provide emergency information in conjunction with the present invention. In an alternative embodiment, the notification terminal may turn on a television set, radio, set-top box or video player, or other audio or visual equipment or consumer electronic device, by generating remote control signals instead of being implemented as an embedded or add-in component of the television set, radio, set-top box, video player, or other audio or visual equipment or consumer electronic device.

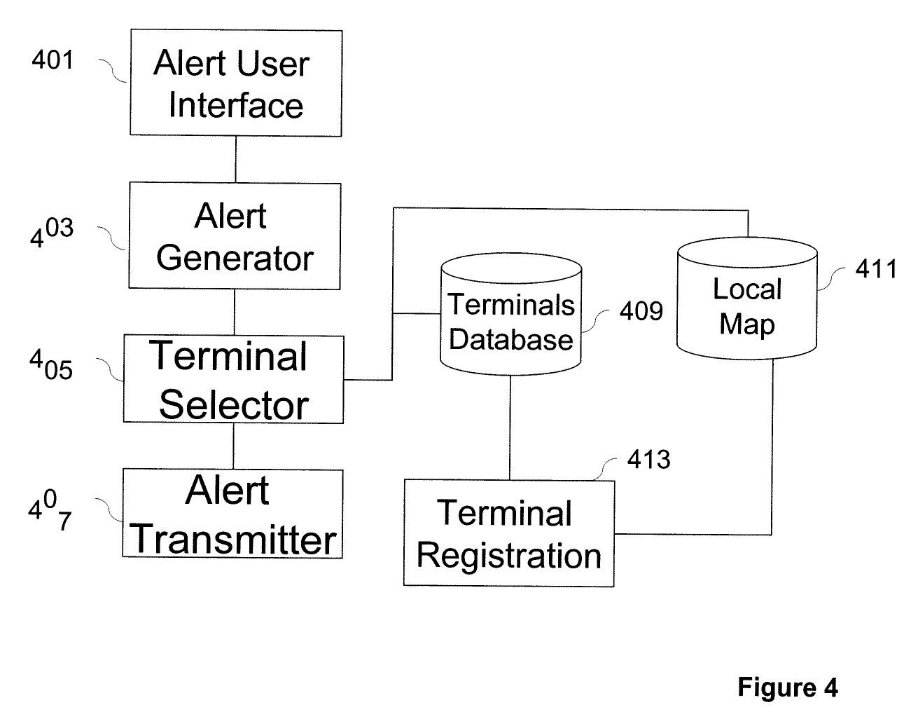

FIG. 4 shows the structure of the software that can be used to implement an emergency notification server according to the invention. This software runs on a computer that has the ability to communicate via a wide area wireless network protocol. The software consists of an alert user interface 401 which is used to provide information about new alerts to the system. One embodiment of the alert user interface 401 would be to implement it as a web-based application that can be accessed using a standard web browser. A set of forms allow an alert administrator to specify the location and other attributes of an emergency location to this web-based application. In a typical usage scenario, the role of the alert administrator can be played by a policeman, a fireman, a local government official, or an employee of a emergency management agency like FEMA. Other alternate embodiments of the alert user interface can consist of a command line interface, or a graphical user interface that allow the alert administrator to input information about the alert. The information input into the alert user interface is passed onto the alert generator 403. The alert generator 403 creates a representation of the alert into a computer readable representation. The computer readable representation could be rendered in several formats, including representations using a structured language like XML, or standard alert representations such as CAP (Common Alert Protocol). When the representation of the alert is obtained, the terminal selector 405 is used to identify which of the several emergency alert terminals ought to be notified. This selection is made by looking at several sources of data, including but not limited to a Terminal Database 409) and a database of the local map 411. The Terminal Database 409 contains information about several alert terminals that are registered with the alert server. The registration information would contain the location of the alert terminals as well as their identity. For an alert, different types of notification messages may need to be created, e.g., a flood emergency can result in different levels of notification messages—a flood emergency notification to terminals located in low-lying areas which are highly likely to be flooded, a flood-warning notice to terminals lying in area which has a somewhat moderate likelihood of being flooded, and a flood watch notice to terminals in the area that have a low but non-negligible chance of being flooded. The local map 411 contains information about the addresses, roads, physical terrain and other aspects of the neighborhood which are used to determine what type of notifications ought to be going out to different set of alert terminals. Once the set of terminals has been selected, the alert notification is passed onto the alert transmitter 407 which then transmits the information over to the alert terminals that are affected.

The alert transmitter 407 may use a variety of formats to transmit the alert to the receiving terminals. One possible embodiment of the transmitter may create specific messages for each receiving terminal and send the message individually to each of the receiving terminals. If there are N terminals which have to receive the emergency notification, N messages would be sent on the network. Other embodiments can achieve a more timely and efficient transmission by leveraging the multicast facilities available on a wireless network. One possible embodiment can create a message which contains the identity of all receiving terminals for the message and transmit a single instance of that message on the wireless network. Each terminal receiving the message would validate that it is one of the intended receivers and act upon that message, or otherwise ignore that message. In this case, only one message is sent on the wireless network regardless of the number of receiving terminals. If there are more than one type of notifications which needs to be transmitted (e.g. a flood emergency notification, a flood warning notification, a flood-watch notification), one message per type needs to be transmitted. An alternate embodiment may combine different types of emergency notifications into a single message. A single message with all three types of notification information, as well as three lists of terminals that receive those messages is transmitted. Each of the receiving terminals can select the type of notification they are required to act upon.

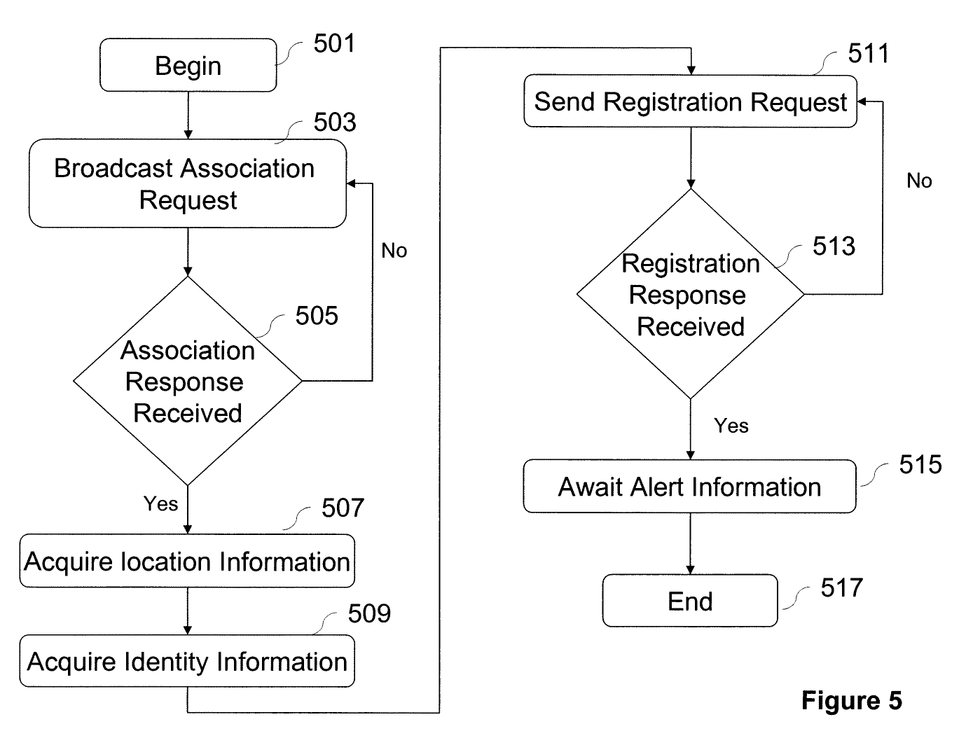

In most cases, effective implementation of the emergency notification system will require alert terminals in a specific area to register themselves to the local emergency alert server. Such registration mechanism populates the Terminal Database 411. Such a registration mechanism must minimize the amount of steps that a human being needs to undertake to complete the registration. Accordingly, FIG. 5 demonstrates the algorithm for a registration process which can be implemented in an automated manner by emergency alert terminals without requiring any human involvement. The algorithm is entered in step 501 when an alert terminal is powered on, or otherwise installed into any given premises. In step 503, the terminal broadcasts an association request on the wireless medium. Such request is intended to find out if there are any emergency alert servers that are active in the locality. Any or all of the emergency alert servers present in the area may respond to the association request. In step 505, the terminal checks to see if it has received a response from any of the servers. If it has not, it returns to step 501. The terminal will keep on broadcasting an association request until it is associated with at least one alert server. If it has received a response from at least one emergency alert server, it will continue onto the step 507. In step 507, the terminal will acquire its location information. For an alert terminal that is equipped with GPS location information or equivalent systems, the location information can be obtained automatically. For other terminals, the information may need to be obtained on the basis of human input which was provided during the configuration of the alert terminal. In step 509, the terminal obtains its identity. The identity can be a unique identifier (e.g. manufacturer name, machine type and a machine serial number) which identifies the machine. Other means for generating identity information can also be used. As an example, a very large number can be generated randomly, with a negligible probability of conflict, and used as an identity. Subsequently, in step 511, the terminal sends a registration message to the alert server which may have sent a response back to it. It checks in step 513 if a positive response to the registration is received. If not, the step 511 is repeated. If a positive response has been received, then the terminal goes into step 515 where it awaits any emergency alert from the server. The process then ends in step 517. If there is more than one emergency alert server, the steps from 511 through 513 may be repeated.

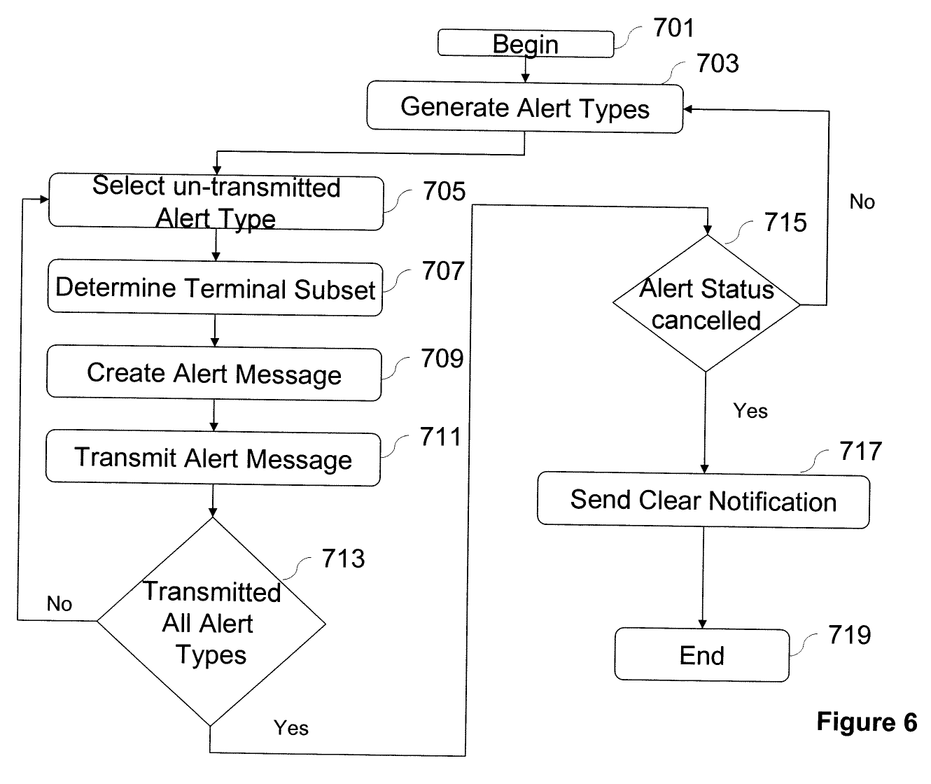

FIG. 6 shows the state transition that an emergency alert terminal goes through the registration process. It starts in the unassociated state 601 when it is powered on or initialized. It moves over to the associated state 603 when it finds a nearby emergency alert server and successfully associates with it. When it has been able to successfully send its identity and location information to an emergency alert server, it moves into a registered state 605. It would move from the registered state to an alerting state 607 when it receives an emergency alert from the server. In the alerting state, the terminal uses audio visual means to generate alert information for consumers in the household. If the server sends a clear message canceling the alert, the terminal moves back to the registered state 605. In case of any error conditions happening, the terminal resets itself to the unassociated state 601.

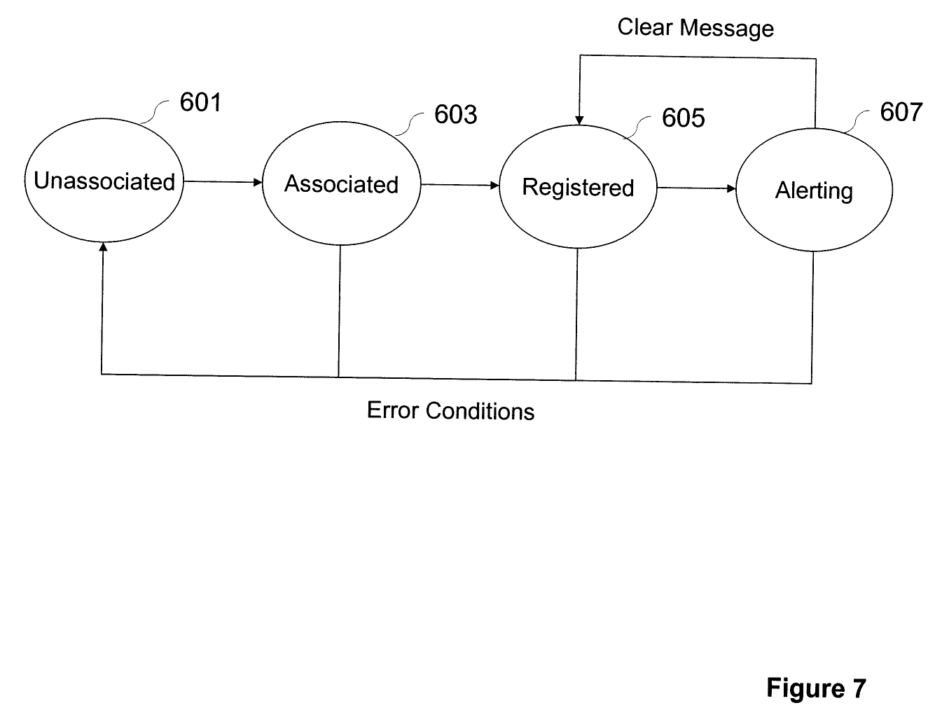

FIG. 7 shows the algorithm that is used by an emergency alert server to send alert messages to the different terminals. The algorithm is entered in step 701 when an emergency alert is input into the server. In step 703, the system determines whether the emergency alert needs to be transmitted in different levels of severity or different types. For an alert, different types of notification messages may need to be created, e.g. a flood emergency can result in different levels of notification messages—a flood emergency notification to terminals located in low-lying areas which are highly likely to be flooded, a flood-warning notice to terminals lying in area which has a somewhat moderate likelihood of being flooded, and a flood watch notice to terminals in the area that have a low but non-negligible chance of being flooded. Step 705 through steps 711 are repeated for each of the alert types. In step 705, one of the untransmitted alert types is selected. In step 707, the set of terminals corresponding to this alert type are selected. The rendering of this message into the format that can be transmitted is selected in step 709. In step 711, the alert message is transmitted. If step 713, the algorithm checks if all the message types have been transmitted. If not, the algorithm continues with step 705. In step 715, the algorithm checks if the algorithm checks if the alert system has been cancelled. If not, the algorithm repeats the steps from 703 onwards. Otherwise, if the alert status has been cancelled, the algorithm transmits a clear notification in step 717. Thereafter, the algorithm terminates in step 719.

An alternate embodiment may operate in a manner which eliminates the need to have a registration database. The emergency alert system may transfer the alert along with a set of rules that determine which set of terminals should receive a specific alert message. As an example, a rule may indicate that all terminals with GPS or geospatial coordinates within a given range should receive the message. This type of broadcast will be received by any terminal within the transmission range of the emergency alert server and the user be given appropriate notification

While the invention has been described in terms of its preferred embodiments, those skilled in the art will recognize that the invention can be practiced with modification within the spirit and scope of the appended claims.

Having thus described our invention, what we claim as new and desire to secure by Letters Patent is as follows:

1. An emergency notification terminal, comprising:
means for obtaining location identification information;
receiver for receiving emergency notification alerts provided through said emergency notification network; and
signaling mechanism for providing signals relating to one or more emergency notification alerts received by said receiver.

2. The terminal of claim 1, wherein said means for obtaining location identification information comprises a global position determining device.

3. The terminal of claim 1, wherein said means for obtaining location identification information stores said location information locally at said terminal.

4. The terminal of claim 3, wherein said means for obtaining and storing location identification information compares said locally stored location information to rules received from said emergency notification network

5. The terminal of claim 1, wherein said means for receiving emergency notifications interfaces to a wireless network.

6. The terminal of claim 1, wherein said means for obtaining location identification information includes a terminal identifier which user transmits to said emergency notification network.

7. The terminal of claim 1, wherein said signaling mechanism for notifying users causes audio or visual equipment to be activated.

8. The terminal of claim 1, wherein said receiver for receiving emergency alerts compares a set of rules received from said emergency notification network to determine, on the basis of location information available locally at said terminal, whether an alert is applicable to said terminal.

9. An emergency notification server, comprising:
an alert user interface that allows users to input alert information;
an alert generator module that allows for creation of an alert message;
a terminal selector module to select a set of terminals to send an alert message; and
an alert transmitter that transmits the alert message over a wireless network.

10. The emergency notification server of claim 9, wherein the terminal selector module uses geographic location information to select the set of terminals that receive the alert message.

11. An emergency notification system, comprising:
a plurality of emergency notification terminals positioned at a plurality of different geographical locations, each of said emergency notification terminals capable of receiving emergency notification alerts provided through an emergency notification network, and providing signals related to one or more emergency notification alerts;
means for determining, on the basis of a terminal's location, whether an alert is applicable to said terminal;
a transmitter for transmitting one or more emergency notification alerts to one or more of said plurality of emergency notification terminals through said emergency notification network.

12. The emergency notification system of claim 11 wherein said means for determining, on the basis of a terminal's location, whether an alert is applicable to said terminal comprises a location registry which identifies the location of each of said plurality of emergency notification terminals.

13. The emergency notification system of claim 11 wherein said means for determining, on the basis of a terminal's location, whether an alert is applicable to said terminal comprises a set of rules received from said emergency notification network which enables a terminal to determine, on the basis of location information available locally at said terminal, whether an alert is applicable to said terminal.

14. The emergency notification system of claim 11 wherein said transmitter is capable of transmitting a first emergency notification alert to one subset of said plurality of emergency notification terminals and a second emergency notification alert which is different from said first emergency notification alert to a second subset of said plurality of emergency notification terminals.

15. The emergency notification system of claim 12 wherein said transmitter is capable of transmitting said one or more emergency notification alerts to a subset of said emergency notification terminals selected based on locations of emergency notification terminals in said subset as identified in said location registry.

16. The emergency notification system of claim 12 further comprising a processor for receiving information from one or more sources which pertain to said one or more emergency notification alerts, and for enabling said transmitter to send said one or more emergency notification alerts to one or more of said plurality of emergency notification terminals based on a location of said one or more of said plurality of emergency notification terminals.

17. The emergency notification system of claim 12 wherein at least some of said plurality of emergency notification terminals automatically communicate location information which is incorporated into said location registry.

18. The emergency notification system of claim 11 wherein at least some of said plurality of emergency notification terminals communicate by wireless communication.

19. The emergency notification system of claim 11 wherein at least some of said plurality of emergency notification terminals are equipped with global positioning systems.

20. An emergency notification method, comprising the steps of:
using a computer connected to an emergency notification network to provide emergency notification data;
using an emergency notification server connected to said emergency notification network to transmit said emergency notification data;
having a wireless network connected to said emergency notification server;
using an emergency notification terminal connected to said wireless network to receive emergency notification data from said emergency notification terminal; and
using a user notification system of said emergency notification terminal to distribute emergency notifications based on said emergency notification data.
